(19) United States
(12) Patent Application Publication
(10) Pub. No.: US 2019/0089626 A1
(43) Pub. Date: Mar. 21, 2019

(54) RAPID TOPOLOGY-INDEPENDENT PATH PROTECTION IN SDN NETWORKS

(71) Applicant: NEC Laboratories Europe GmbH, Heidelberg (DE)

(72) Inventor: Anton Matsiuk, Hamburg (DE)

(21) Appl. No.: 16/083,539

(22) PCT Filed: Mar. 31, 2016
(86) PCT No.: PCT/EP2016/057041

§ 371 Date: Sep. 10, 2018

(51) Int. Cl. H04L 12/703; H04L 12/24; H04L 12/707; H04L 12/741

(52) U.S. Cl. CPC H04L 45/28; H04L 41/0654; H04L 45/745; H04L 45/22; H04L 41/0677

(57) ABSTRACT

A method for performing path protection in an SDN network includes: establishing protected connections, wherein each of the protected connections is between two endpoint switches and includes a working path along a first set of intermediate switches and at least one protection path along a second set of intermediate switches; providing metadata to the switches, the metadata carrying information about the endpoint switches of protected connections together with a unique identifier allocated to each of the protected connections or to a group of the protected connections following the same path; by the intermediate switches, in case of experiencing a local port and/or link failure, using the metadata to generate a failure message towards endpoint switches of the connections affected by the port and/or link failure; and by the endpoint switches, upon receiving a failure message, switching the affected connections from their working path to their at least one protection path.

### CROSS-REFERENCE TO PRIOR APPLICATIONS

This application is a U.S. National Stage Application under 35 U.S.C. § 371 of International Application No. PCT/EP2016/057041 filed on Mar. 31, 2016. The International Application was published in English on Oct. 5, 2017 as WO 2017/167371 Al under PCT Article 21(2).

### FIELD

The present invention generally relates to a method and a system for performing path protection in an SDN network.

### BACKGROUND

Traditional routing protocols rely on re-computation of forwarding paths in case of network failures and thus expose slow convergence time (which is in the range of sub-seconds to seconds). However, such failure switchover time becomes inacceptable for real-time and mission-critical applications which may require switchover time of less than 50 ms. To tackle this issue, several extensions to distributed control plane protocols were designed. One of the typical approaches is to enable local protection primitives along the path: protection of nodes and links (as described, for instance, in P. Pan, G. Swallow, A. Atlas: “Fast Reroute Extensions to RSVP-TE for LSP Tunnels”, IETF, Network Working Group, RFC 4090, May 2005). However, such extensions are topology-dependent and operate, in fact, at a segment level. Additionally, maintenance of a large number of protected segments turns into a scalability problem and do not address resource availability along the protection segments.

On the other hand, several end-to-end L2 path protection mechanisms for distributed and centralized control planes are based on propagation of per-path keepalives (e.g. ITU-T rec. G.8031, G.8032). However, it is hard to transfer these approaches into flexible-matching architectures with centralized control like OpenFlow. First, finding proper values of packet headers for keepalive messages is an NP-hard problem (for reference see, for instance, P. Peres̆ini, M. Kuzniar, D. Kostic: “Monocle: Dynamic, Fine-Grained Data Plane Monitoring”, CoNEXT'15, Heidelberg, Germany, 2015), especially in networks with highly dynamic forwarding state. Second, installation of specific forwarding rules for per-flow keepalives increases number of flows in data plane and limits its scalability. Third, keepalive mechanisms need to be congestion-tolerant to prevent false switchovers which decreases their effectiveness and slows down the reaction time.

OpenFlow protocol v.1.3.1+ has an inherent switchover mechanism for local failures implemented by means of FastFailover groups (for reference, see OpenFlow Switch Specification, Version 1.3.1 (Wire Protocol 0x04), Sep. 6, 2012, https://www. opennetworking. org/images/stories/downloads/sdn-resources/onf-specifications/openflow/openflow-spec-v1.3.1.pdf, in particular chapter “5.6 Group Table”). If a switch detects a local port failure (e.g. in case of loss of optical signal or keepalive messages from a neighbor) the protected flow is switched to a next live bucket (i.e. port or logical group of ports).

However, first of all, the present inventors have recognized that the mentioned approach is topology dependent and works properly only in reaction to port and/or link failures that occur in the direct neighborhood of endpoints switches of protected connections. Furthermore, enabling path protection according to this mechanism requires interaction with the SDN controller, which goes through a slow OpenFlow control channel and the switchover time depends on the switch's architecture as well as on the architecture of SDN controller. In fact, the rate of updating of forwarding pipelines and processing of OpenFlow messages are among the main bottlenecks of hardware-based switching architectures (for reference, see Roberto Bifulco and Anton Matsiuk: “Towards Scalable SDN Switches: Enabling Faster Flow Table Entries Installation”, Proceedings of the 2015 ACM Conference on Special Interest Group on Data Communication (SIGCOMM '15). ACM, New York, N.Y., USA, 343-344, DOI=http://dx.doi.org/10.1145/2785956.2790008). Additionally, processing of OpenFlow asynchronous messages in modem controller architectures (e.g. OpenDaylight, ONOS etc.) typically requires an interaction of their several internal modules, and, therefore, the switchover becomes slow and inacceptable for mission-critical applications.

### SUMMARY

An embodiment of the present invention provides a method for performing path protection in an SDN network, which has a plurality of switches, that includes: establishing protected connections, wherein each of the protected connections is between two endpoint switches and includes a working path along a first set of intermediate switches and at least one protection path along a second set of intermediate switches, the switches comprising the endpoint switches, the first set of intermediate switches, and the second set of intermediate switches; providing metadata to the switches, the metadata carrying information about the endpoint switches of protected connections together with a unique identifier allocated to each of the protected connections or to a group of the protected connections following the same path; by the intermediate switches, in case of experiencing a local port and/or link failure, using the metadata to generate a failure message towards endpoint switches of the connections affected by the port and/or link failure; and by the endpoint switches, upon receiving a failure message, switching the affected connections from their working path to their at least one protection path.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic view illustrating a network example demonstrating the OpenFlow local protection mechanism;

FIG. 2 is a schematic view illustrating the general concept of a protection switching architecture in accordance with embodiments of the present invention;

FIG. 3 is a schematic view illustrating a 1:1 protection scheme implementation in accordance with embodiments of the present invention;

FIG. 4 is a schematic view illustrating a 1+1 protection scheme implementation in accordance with embodiments of the present invention;

FIG. 5 is a schematic view illustrating an example of a neighbor exchange protocol in accordance with embodiments of the present invention; and

FIG. 6 is a schematic view illustrating a ring protection scheme implementation in accordance with embodiments of the present invention.

### DETAILED DESCRIPTION

Embodiments of the present invention improve and further develop a method and a system for performing path protection in an SDN network in such a way that the switchover from a working path to a protection path can be carried out rapidly and in a topology-independent way.

In an embodiment the present invention provides a method for performing path protection in an SDN network, including:

establishing protected connections, where each of the protected connections is between two endpoint switches and includes a working path along a first set of intermediate switches and at least one protection path along a second set of intermediate switches,

providing metadata to the switches, the metadata carrying information about the endpoint switches of protected connections together with a unique identifier allocated to each of the protected connections or to a group of the protected connections following the same path,

by the intermediate switches, in case of experiencing a local port and/or link failure, using the metadata to generate a failure message towards endpoint switches of the connections affected by the port and/or link failure, and

by the endpoint switches, upon receiving a failure message, switching the affected connections from their working path to their at least one protection path.

Furthermore, in an embodiment the present invention provides a system, including

an SDN network including a plurality of switches, a network controller being connected to one or more of the plurality of switches, and a number of protected connections, where each of the protected connections is between two endpoint switches and includes a working path along a first set of intermediate switches and at least one protection path along a second set of intermediate switches,

the intermediate switches being configured, in case of experiencing a port and/or link failure, to use information about the endpoint switches of protected connections together with a unique identifier allocated to each of the protected connections or to a group of the protected connections following the same path to generate failure messages towards endpoint switches of the connections affected by the port and/or link failure, and

the endpoint switches being configured, upon receiving a failure message, to switch the affected connections from their working path to their at least one protection path.

According to the invention, it has been recognized that the above mentioned improvement can be accomplished by providing extensions to the communication protocol employed in the SDN network, e.g. the OpenFlow protocol, in form of metadata that enable a centralized computation and programming of working and protection paths and delegation of reactions on network failures to SDN switches. Thus, the present invention provides a method and a system for fast and topology-independent path protection switchover in SDN networks with centralized management of protected paths and local reaction to network failures. Implementations of the present invention achieve accelerated failure switchover time for end-to-end protected paths in SDN networks. Embodiments of the invention achieve a decrease in the number of flows and links which are required to implement the path protection with local switchover mechanisms (e.g. OpenFlow FastFailover groups). Furthermore, the method according to the invention works in a topology independent way.

According to an embodiment of the present invention, the metadata may include a dedicated flag allocated to network flows that informs switches along a network flow's forwarding path whether a respective network flow belongs to a protected or to an unprotected connection.

According to a further embodiment of the present invention, the metadata may also include a dedicated identifier, denoted hereinafter protection ID, for uniquely identifying a protected connection or a group of protected connections following the same network path.

According to a still further embodiment of the present invention, the metadata may also include an address of a head- or tail-endpoint switch of a protected connection.

With respect to all metadata mentioned above, it may be provided that it is integrated into existing OpenFlow semantics.

According to an embodiment, the switches may use the metadata to identify those connections that are affected by a local port and/or link failure. Based thereupon, the switches may use the metadata to generate port and/or link failure notification messages and to transmit them via the data plane towards endpoint switches of protected connections affected by the respective port and/or link failure. According to an embodiment of figure notification messages may be constructed to carry the address of the head- or tail-endpoint switch of the affected connection as destination address and to also carry the protection ID of the affected connection, for instance as payload.

According to an embodiment, the switches may include an agent, which may be an OpenFlow agent, that is configured to extract extension fields, carrying the metadata, from messages the respective switch receives from the SDN controller. The extracted extension fields may be passed to a specific table extension table provided at the switch.

As already mentioned above, according to an embodiment, the switches may also include an extension table that receives extracted extension fields from the OpenFlow agent. Specifically, in the extension table correspondences between local output ports of a respective switch and endpoint switches of protected connections may be stored.

According to an embodiment, the switches may also include a failure logic module that is configured to identify protected connections affected by a local port and/or link failure and to generate, based on the metadata, a specific failure notification message towards endpoint switches of the affected connections.

According to an embodiment, the switches may also include a failure logic module that is configured to extract port and/or link failure notification messages from the data plane and to associate these messages with locally protected forwarding rules. This module enables reactions on the failure modification messages at endpoint switches of affected connections and may perform a local switchover of these connections to protection paths.

In particular, according to embodiments of the present invention, the following extensions to existing solutions in the related art, e.g. standard OpenFlow technology and common SDN switch architecture, may be considered:
1) Extensions to SDN controller logic and related SDN protocol messages which enable generation and distribution of an additional metadata together with forwarding rules towards the SDN switches. Such a metadata carries information about the endpoint switches of the protected connections and their unique identifiers and is intended for delegation of failure notifications to the intermediate switches of protected connections.
2) An extension to SDN switches which allow to extract and store the additional metadata locally in the switches and to relate it to local forwarding actions.
3) An extension to SDN switches which allows to generate failure notification messages towards the endpoints of protected connections in reaction to local link or port failures and to inject them into the data plane thus enabling rapid propagation of messages. To this end, i.e. to support a rapid propagation of failure messages in the data plane, the switches may be configured with a set of appropriate forwarding rules.
4) An extension to SDN switches which extracts failure notification messages from the data plane at the connection endpoints, associates them with locally protected forwarding rules and takes required actions to perform switchovers of protected connections.

There are several ways how to design and further develop the teaching of the present invention in an advantageous way. To this end it is to be referred to the dependent patent claims on the one hand and to the following explanation of preferred embodiments of the invention by way of example, illustrated by the drawing on the other hand. In connection with the explanation of the preferred embodiments of the invention by the aid of the drawing, generally preferred embodiments and further developments of the teaching will be explained.

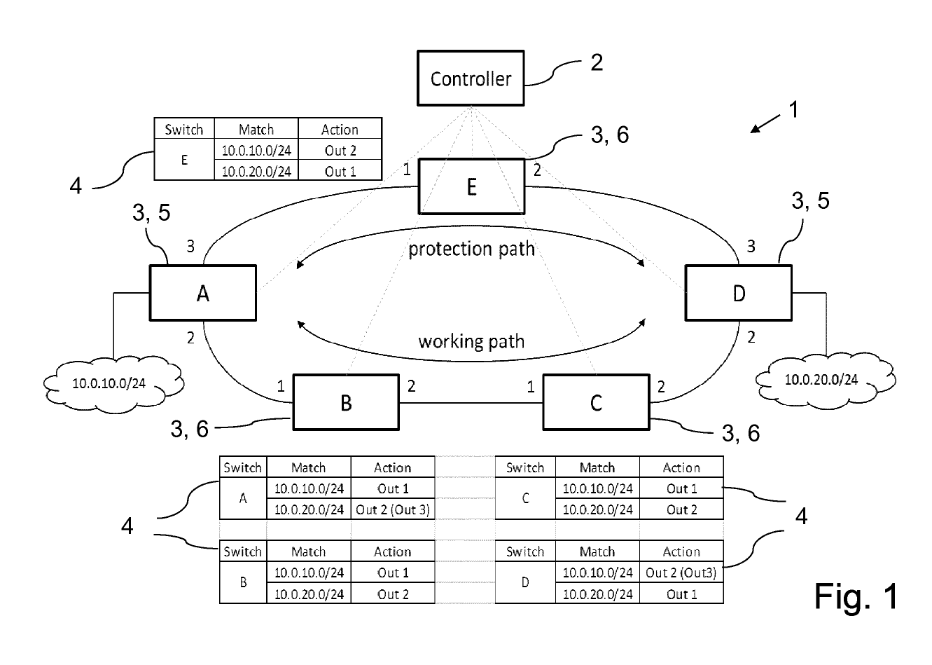

FIG. 1 schematically illustrates the switchover mechanism for local failures implemented in OpenFlow protocol v.1.3.1+ by means of FastFailover groups. According to this mechanism, if a switch detects a local port failure (e.g. in case of loss of optical signal or keepalive messages from a neighbor) the protected flow is switched to a next live bucket (i.e. port or logical group of ports). To illustrate this mechanism, in the exemplary SDN network 1 depicted in FIG. 1, the SDN Controller 2 installs flows into the SDN switches 3, denoted A-E in FIG. 1, by Flow-mod messages containing match and action parts. The match field may contain exact and/or wildcard of one or more packet headers, and the action part typically contains one or more instructions including forwarding the flow out of a specific interface. FIG. 1 shows content of the switches' 3 flow tables 4 which is needed and sufficient for L3 forwarding scenario between networks 10.0.10/24 and 10.0.20/24 matching on destination IP address fields.

In the illustrated example, a protected connection is established between two endpoint switches 5, denoted A and D, where the working path is via intermediate switches 6 denoted B and C and the protection path is via intermediate switch 6 denoted E. FastFailover protection groups are able to react on local switch port failures (e.g. between A and B) selecting the protection ports in the group without an interaction with a controller, i.e. SDN controller 2. However, if the link between switches B and C fails, the endpoint switches A and D of the protected connection will not be aware of this failure and will not switch their forwarding paths. A common way in SDN architectures to handle such a problem is let the switches detecting local failures contact the controller with Port_Status or Packet-in asynchronous messages. In reaction to these messages the controller enables a protecting path with Flow-mod messages. However, this interaction goes through a slow OpenFlow control channel and the switchover time depends on the switch's architecture as well as on the architecture of SDN controller 2. Consequently, the switchover is not topology-independent. Furthermore, since the processing of OpenFlow asynchronous messages in modern controller architectures typically requires an interaction of their several internal modules, the switchover becomes slow and might be inacceptable for certain critical applications.

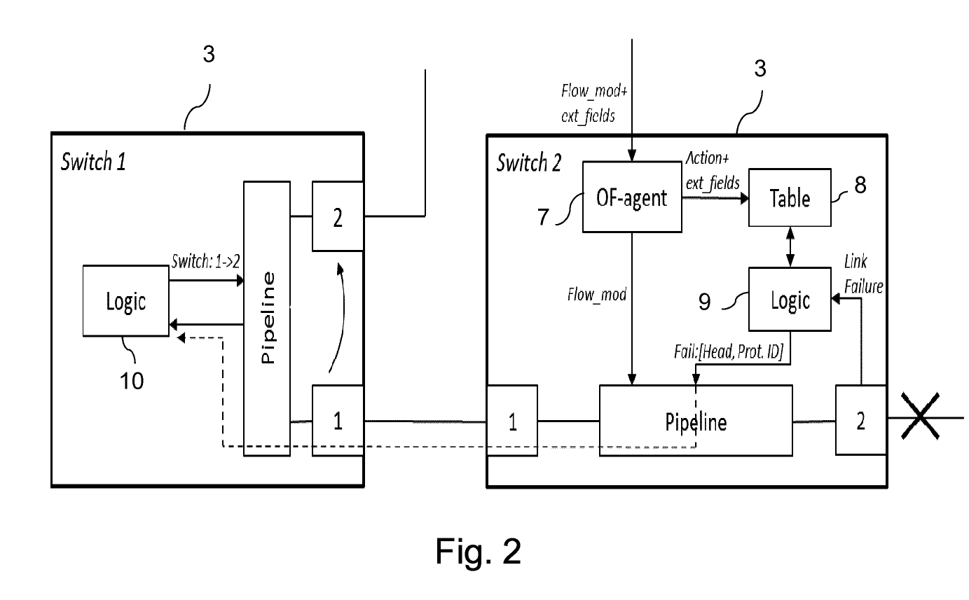

FIG. 2 schematically illustrates the general concept of a protection switching architecture in accordance with an embodiment of the present invention that is capable of overcoming the disadvantageous discussed above in connection with the scenario of FIG. 1. Although in the embodiment the SDN controller 2 and the SDN switches 3 operate by using the OpenFlow protocol, any other protocol with similar or comparable characteristic that enable remote controlling of network plane elements may be used likewise, as will be easily appreciated by those skilled in the art.

To enable centralized computation of working and protection paths and distribution of correspondent flows from the SDN controller 2 into the switching engines, it is assumed in the illustrated embodiments that the standard OpenFlow semantics (in particular the Flow-mod message structure) is extended with the following additional fields: A ‘Protection Flag’ informs the switches 3 whether a flow is part of a protected or unprotected connection. A ‘Protection ID’ is a unique and locally significant identifier for every protected connection or a group of protected connections following the same path between a specific head- and tail-endpoint switch 5. Finally, the item ‘Head’ or ‘Tail’ is an address of a head- or tail-endpoint switch 5 of a protected connection.

With respect to the mentioned OpenFlow extensions, it should be noted that extension fields are subordinate to the general OpenFlow semantics and thus may be modified within already installed flows by OFPFC_MODIFY OpenFlow messages (e.g. in case of re-routing or addition/removal of protection paths). Furthermore, appropriate extensions may be also required to other OpenFlow messages to enable, for example, a proper per-flow statistic collection or notifications of the controller 2 about the protection switchovers. However, such extensions do not impact the failure switchover logic and are not further considered here.

The above mentioned extension fields should not violate programming abstractions of the OpenFlow forwarding pipeline. Thus, in accordance with embodiments of the present invention, the OpenFlow agent 7 of the switches 3 is configured and modified to extract these fields from Flow-mod messages, as shown at (failure notification sending) switch #2 in FIG. 2. The modified agent 7 recognizes all the flows with Protection Flag enabled and populates an extension table 8. The extension table 8 may be implemented as a hash-table with key-value pairs, where the keys are the output ports of Flow-mod' s forwarding actions and the values contain a tuple of Protection ID and Heads (or Tails) of protected connections. This table 8 can be stored, for example, in a traditional RAM memory which is typically a part of “bare metal” (or white-box) switching platforms (for reference, see Opennetlinux: https://opennetlinux.org/). The Flow-mod messages without extracted fields are then processed further as normal OpenFlow messages.

In addition, the switches 3 also include a specific failure logic module 9 that is configured to keep track of the liveliness of local ports (or links) and, in case of a port (or link) failure, to perform a lookup in the extension table 8 with the failed port ID as a key and to extract the values—Protection IDs and Heads (or Tails) of the affected connections. The failure logic 9 can be executed on a generic CPU of the switch and may be implemented as a separate software module of the switch's 3 OS (as generally known from Opennetlinux: https://opennetlinux.org/). The failure logic 9 generates failure messages towards the head-ends or tail-ends of the affected connections using extracted Heads or Tails values as destination address and Protection IDs as payload. The message can be generated, e.g., by filling a predefined L2/L3 packet template with extracted values. The Heads or Tails may be any kind of L2/L3 addresses (e.g. management or loopback IP addresses of the remote switches) and can use either in-band or out-of-band management network for message delivery. A specific set of unicast or multicast flows should be preinstalled in the management network to enable rapid delivery of messages keeping them in the data plane on the way to the head- or tail-end switches 5. Such a rapid propagation of failure notifications accelerates the failure switchover comparing to per-hop decisions in the control plane (e.g. in legacy distributed protocols).

Once a failure message reaches its destination (i.e. the head- or the tail-endpoint switch 5 of the respective connection) it is extracted from the data plane and forwarded to the receiver failover logic 10, as shown at the exemplary depicted (failure notification receiving) switch #1. This logic 10 may be collocated with the sender failover logic 9 into a single extension module. The receiver logic 10 extracts Protection IDs of the connections which need to be switched to protection paths and sends a switchover command to the underlying forwarding pipeline. Such a command may be, for example, a locally generated Flow-mod message modifying the output port of the protected flows or a “bucket down” message which will cause FastFailover OpenFlow groups to switch to a protection output port. In the latter case, however, the failover logic 10 has to allocate a range of logical buckets and to associate a separate bucket with every Protection IDs to keep the connection switchovers independent from local physical port switchovers.

A revertive mode may be implemented with an introduction of an additional type of failure message. The message must inform the head- or the tail-endpoint switch 5 about a restored working path which will cause receiver logic 10 to switch the flows back to the working path.

Before explaining specific embodiments of the present invention in detail, a possible implementation of the present invention will be by described in a more general way, in order to provide an overview of the single steps, which will then be described in more detail below in connection with the specific embodiments. According to a general implementation the following steps may be executed:
1) Define a path computation mechanism for finding of working and protected paths in an SDN controller;
2) Define a strategy for allocation of protection IDs for protected connections;
3) Allocate a specific set of addresses and forwarding flows allowing the SDN switches to communicate to each other through data plane;
4) Extend the semantic of OpenFlow messages with the extension fields;
5) Modify an architecture of an SDN switch with additional logic modules which allow to extract the extension fields from OpenFlow messages, to store them and to relate to local forwarding rules;
6) Modify an architecture of an SDN switch which allows to identify the affected protected connections by means of extension fields lookups in case of local failures;
7) Modify an architecture of an SDN switch with additional logic which allows to generate failure notification messages, receive and react on such messages.

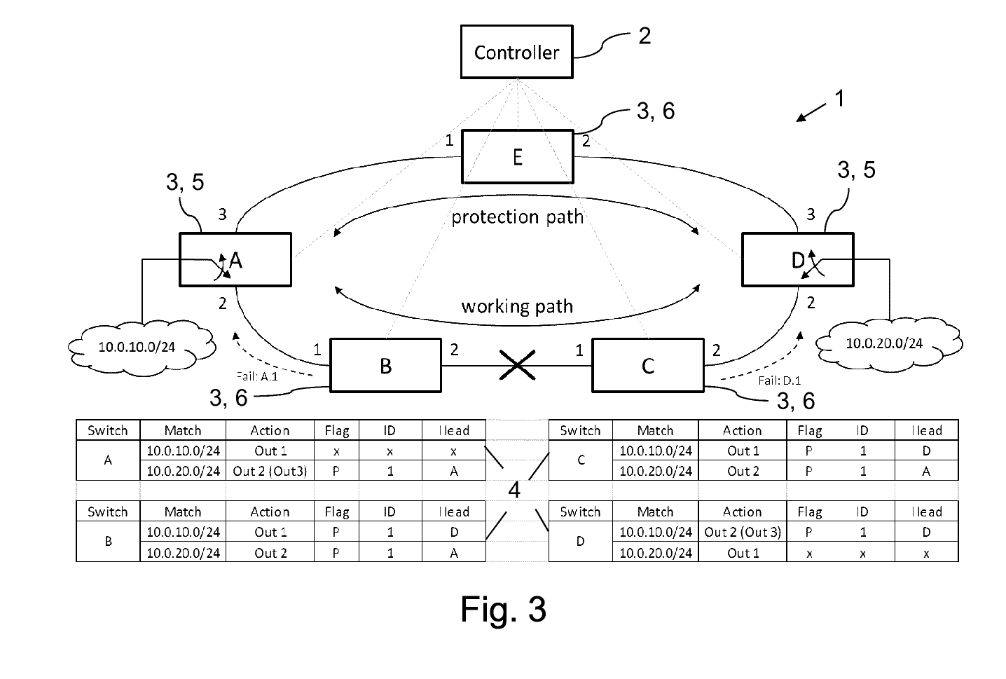

Turning now to FIG. 3, this figure illustrates an embodiment of the present invention according to which a 1:1 protection scheme is implemented, i.e. a certain protection path is exclusively allocated to a particular working path of a protected connection. Such 1:1 protection scheme implies the propagation of traffic along the protection path only after failure at the working path occurs. Therefore, a necessary and sufficient condition to meet the requirements of such a scheme is to perform a protection switchover at the head-endpoint switch 5 of the protected connection, while the tail-endpoint switch 5 can receive the traffic from both paths in parallel. Such, the failure messages need to be forwarded to the head-endpoint switches 5 of the protected connections.

FIG. 3 shows the same network architecture as FIG. 1 with like reference numbers denoting like components. Specifically, FIG. 3 depicts Flow-mods installed in the switches A-D t hat are extended in accordance with embodiments of the present invention. Furthermore, FIG. 3 depicts the propagation of failure messages and switchover in case of link failure between switches B and C. The forwarding flows of the protection paths (including intermediate switch E) are identical to the flows installed in the working path (including intermediate switches B and C) and are therefore omitted in FIG. 3. As illustrated in FIG. 3, each switch's 3 flow table 4 includes a match part (indicating the destination network or address of the respective flow) and an action part (specifying the switch's 3 output port for forwarding the respective flow). The extensions of the flow table 4 introduced by embodiments of the present invention include a flag (‘Protection Flag’) informing the switch 3 whether a flow is part of a protected (‘P’) or unprotected (‘x’) connection, an ID (‘Protection ID’) being a unique and locally significant identifier for every protected connection or a group of protected connections following the same path between a specific head- and tail-endpoint switch 5 (in FIG. 3, flows belonging to the only protected connection have the ID ‘1’, while flows belonging to unprotected connections have the ID ‘x’), and a part denoted ‘Head’, which specifies the address of a head-endpoint switch 5 of a protected connection.

The scenario of FIG. 3 assumes a link failure between switches B and C. From the perspective of switch B its output port 2 is affected. According to switch B's flow table 4 this port is involved in handling traffic with the destination dst. ip=10.0.20.0/24 that belongs to a protected (flag ‘P’) connection (Protection ID ‘1’) with head-endpoint switch A. Consequently, in accordance with an embodiment of the invention, switch B's internal failure logic module 9 (as shown in FIG. 2) generates a failure notification message that contains the extracted Head ‘A’ as destination address and Protection ID ‘1’ as payload. This message is injected into the data plane and transmitted to endpoint switch A. Similarly, intermediate switch C, whose output port 1 is affected by the link failure, generates and transmits a respective failure notification message towards the corresponding head-endpoint switch D.

Upon reception of switch B's failure notification message at endpoint switch A, the message is extracted from the data plane and forwarded to switch A's receiver failure logic module 10 (as shown in FIG. 2). Here, the protection IDs of the connections which need to be switched to a protection path are extracted, which in the present case is connection with ID ‘1’. Based thereupon, the failure logic module 10 generates and sends a corresponding switchover command to the underlying forwarding pipeline. Consequently, as can be obtained from switch A's flow table 4 the output port for forwarding traffic of connection with ID ‘1’ towards network 10.0.20.0/24 is switched from output port 2 to output port 3. Similar actions are taken by endpoint switch D upon receipt of switch C's failure notification message.

It should be noted that an 1:N protection scheme may be derived from 1:1 protection scheme straightforwardly by allocating the same protection path between N protected connections. However, the flows for all N connections along the protection path have to be preinstalled and the switchover logic (considering, e.g., priorities and criteria) has to be implemented on the controller side (e.g. QoS marks as priorities and available bandwidth budget as criteria).

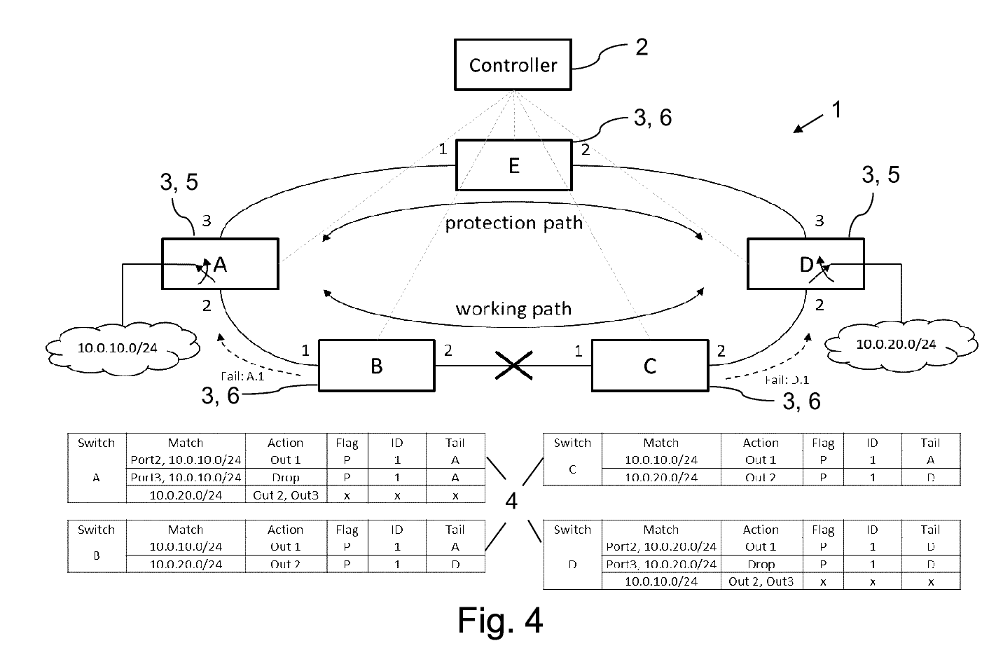

FIG. 4 illustrates an embodiment of the present invention according to which a 1+1 protection scheme is implemented. Again, FIG. 4 relates to the same network architecture as FIGS. 1 and 3 with like reference numbers denoting like components.

A 1+1 protection scheme implies the propagation of traffic along the protection path in parallel to the working path. The protection switchover happens at the tail-endpoint switches 5, which may, for example, decrease the packet loss comparing to the 1:1 scheme during the switchover phase. Here, the failure messages need to be forwarded to the tail-endpoint switches 5 of the protected connection (as shown in FIG. 4). Apart from this difference, the failure notification message generation and transmission basically follows the approach described above in connection with FIG. 3.

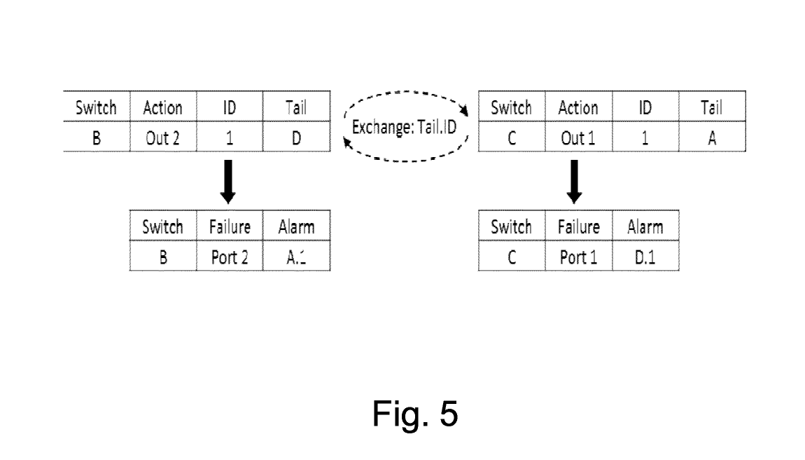

However, in some cases (e.g. with in-band management signaling) the failure notification messages may not be able to reach the tail-endpoint switches 5 since they may use the same path as protected unidirectional flows. A first workaround for this issue would be that the SDN controller 2 programs management network flows such that they always use opposite direction (and consequently protection paths) to propagate the failure messages. According to an alternative embodiment, the switches 3 along the working path may run a neighbor exchange protocol. This protocol may inform each of the neighbors about the protected flows and their Tails leaving the neighboring interfaces. The switches 3 receive the neighbor's information to propagate the failure notification messages to the tail-endpoint switches 5 (in the opposite direction to the failed ports). FIG. 5 represents parts of Flow-mod messages extended in accordance with the embodiment of the invention that need to be exchanged between switches B and C (of the embodiment of FIG. 4) and enable the failure notifications to tail-endpoint switches 5.

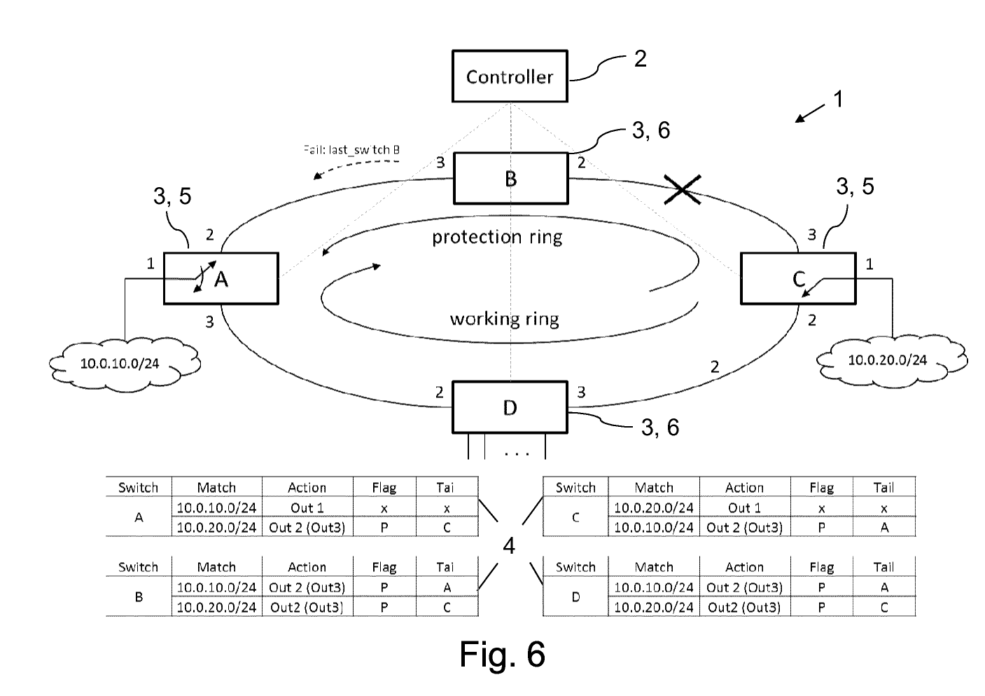

FIG. 6 illustrates an embodiment of the present invention according to which a ring protection scheme is implemented. A ring protection scheme may be considered as a particular case of the 1:1 protection scheme where failure switchover happens at the head-endpoint switches 5. However, given the topology restrictions, the switches 3 operating in the ring may either insert data in the ring or forward it in one of two directions. A common approach in ring topologies is to define forwarding along one direction (e.g. clockwise) as working direction (ring) and another as a protection direction (ring), as illustrated in FIG. 6. The information sufficient for proper switchover includes a direction of the failure and an address of the Last Switch in the ring (after which the failure happens) and, thus, Protection IDs may be omitted. A failure message needs to be sent by a switch 3 attached to the failed link (or ring segment) to a common address of all the switches 3 and has to be forwarded in the protection direction. The switches' 3 addresses are assigned in the increasing order along the working ring.

The receiver failure logic module 9 in intermediate switches 3 compares the Last Switch address with Tails of the installed protected flows. The logic 9 performs switchovers of those connection for which: Tail>Last Switch. Specifically, FIG. 6 illustrates an example, where a failure occurs between switches B and C in a ring topology. In this example, the switches 3 are configured to perform the following actions:
Switches B and C, since being directly attached to a failed link, perform a local switchover;
Switch B propagates a failure modification message with Last Switch 13 across the protection ring;
Switch A performs a switchover for flows matching dst.ip=10.0.20.0/24 from output port 2 to output port 3 (considering the fact that Tail=C>Last Switch=B);
Switch D performs a switchover for flows with dst.ip=10.0.20.0/24 (Tail=C>Last Switch=B) and keeps the working path for dst.ip=10.0.10.0/24 (Tail=A<Last Switch=B).

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

The follow is a list of reference numbers used herein:
1 SDN network
2 SDN controller
3 SDN switch
4 flow table
5 endpoint switch
6 intermediate switch
7 OpenFlow agent
8 extension table
9 failure logic module, sender
10 failure logic module, receiver

1. A method for performing path protection in an SDN network comprising a plurality of switches, the method comprising:
establishing protected connections, wherein each of the protected connections is between two endpoint switches and includes a working path along a first set of intermediate switches and at least one protection path along a second set of intermediate switches, the switches comprising the endpoint switches, the first set of intermediate switches, and the second set of intermediate switches;
providing metadata to the switches, the metadata carrying information about the endpoint switches of protected connections together with a unique identifier allocated to each of the protected connections or to a group of the protected connections following the same path;
by the intermediate switches, in case of experiencing a local port and/or link failure, using the metadata to generate a failure message towards endpoint switches of the connections affected by the port and/or link failure; and
by the endpoint switches, upon receiving a failure message, switching the affected connections from their working path to their at least one protection path.

2. The method according to claim 1, wherein the metadata includes a dedicated flag allocated to network flows that informs the switches whether a respective network flow belongs to a protected or to an unprotected connection.

3. The method according to claim 1, wherein the metadata includes a dedicated identifier, which comprises a protection ID, for uniquely identifying a protected connection or a group of protected connections following the same network path.

4. The method according to claim 1, wherein the metadata includes an address of a head- or tail-endpoint switch of a protected connection.

5. The method according to claim 1, wherein the metadata are integrated into existing OpenFlow semantics.

6. The method according to claim 1, wherein the switches use the metadata to identify those connections that are affected by a local port and/or link failure.

7. The method according to claim 1, wherein the switches use the metadata to generate port and/or link failure notification messages and to transmit them via the data plane towards the endpoint switches protected connections affected by the respective port and/or link failure.

8. The method according to claim 3, wherein a failure notification message uses the address of the head- or tail-endpoint switch of the affected connection as a destination address and the protection ID of the affected connection as a payload.

9. A system for performing path protection in an SDN network, the system comprising:
an SDN network comprising a plurality of switches, a network controller being connected to one or more of the plurality of switches, and a number of protected connections, wherein each of the protected connections is between two endpoint switches of the switches and includes a working path along a first set of intermediate switches of the switches and at least one protection path along a second set of intermediate switches of the switches,
the intermediate switches being configured, in case of experiencing a port and/or link failure, to use information about the endpoint switches of protected connections together with a unique identifier allocated to each of the protected connections or to a group of the protected connections following the same path to generate failure messages towards the endpoint switches of the connections affected by the port and/or link failure, and
the endpoint switches being configured, upon receiving a failure message, to switch the affected connections from their working path to their at least one protection path.

10. The system according to claim 9, wherein the plurality of switches is configured with a set of forwarding rules to support a rapid propagation of failure messages in the data plane.

11. The system according to claim 9, wherein one or more of the plurality of switches comprise an agent, configured to extract extension fields that carry the metadata from messages a respective switch of the switches receives from the controller.

12. The system according to claim 9, wherein one or more of the plurality of switches comprise a table for storing correspondences between local output ports of a respective switch of the switches and the endpoint switches of protected connections.

13. The system according to claim 9, wherein one or more of the plurality of switches comprise a logic module that is configured to identify protected connections affected by a local port and/or link failure and to generate, based on the metadata, a port and/or link failure notification message towards the endpoint switches of the affected connections, and/or
wherein one or more of the plurality of switches comprise a logic module that is configured to extract the port and/or link failure notification messages from the data plane and to associate the port and/or link failure notification messages with locally protected forwarding rules.

14. An SDN network switch, configured for being employed in a method according to claim 1.

15. An SDN network controller, configured for being employed in a system according to claim 9.
